(19) United States
(12) Patent Application Publication
(10) Pub. No.: US 2025/0225142 A1
(43) Pub. Date: Jul. 10, 2025

(54) METHOD, DEVICE, AND STORAGE MEDIUM FOR DATA PROCESSING

(71) Applicant: Bytedance Technology Ltd., Grand Cayman (KY)

(72) Inventors: Hanzhi Yang, Culver City, CA (US); Aleksei Statkevich, Los Angeles, CA (US); Shiqi Zhang, Culver City, CA (US); Wei Zhou, Los Angeles, CA (US); Chuanyun Fang, Culver City, CA (US)

(21) Appl. No.: 19/090,244

(22) Filed: Mar. 25, 2025

(51) Int. Cl. G06F 16/25; G06F 8/30; G06F 8/41

(52) U.S. Cl. CPC G06F 16/254; G06F 8/30; G06F 8/41

(57) ABSTRACT

Embodiments of the disclosure provide a solution for data processing. The solution includes: obtaining a data processing engine instance with static code for a set of processing rules compiled therein, the set of processing rules being configured for at least one party; in response to receiving first data to be processed from a first party of the at least one party, determining at least one first processing rule from the set of processing rules to be applied to the first data based on a data type of the first data; and processing, using the data processing engine instance, the first data by applying the at least one first processing rule, to obtain the processed first data.

### FIELD

The disclosed example embodiments relate generally to the field of computer science, particularly to a method, device, and storage medium for data processing.

### BACKGROUND

An extract, transformation, and load (ETL) engine is a software tool or system used to implement data extraction, transformation, and loading processes. The ETL engine can be deployed to extract data from various data sources, clean and transform the extracted data, and then load the processed data into their target data storage.

### SUMMARY

In a first aspect of the present disclosure, there is provided a method of data processing. The method includes: obtaining a data processing engine instance with static code for a set of processing rules compiled therein, the set of processing rules being configured for at least one party; in response to receiving first data to be processed from a first party of the at least one party, determining at least one first processing rule from the set of processing rules to be applied to the first data based on a data type of the first data; and processing, using the data processing engine instance, the first data by applying the at least one first processing rule, to obtain the processed first data.

In a second aspect of the present disclosure, there is provided an apparatus for data processing. The apparatus includes: an engine instance obtaining module, configured to obtain a data processing engine instance with static code for a set of processing rules compiled therein, the set of processing rules being configured for at least one party; a processing rule determining module, configured to in response to receiving first data to be processed from a first party of the at least one party, determine at least one first processing rule from the set of processing rules to be applied to the first data based on a data type of the first data; and a data processing module, configured to process, using the data processing engine instance, the first data by applying the at least one first processing rule, to obtain the processed first data.

In a third aspect of the present disclosure, there is provided an electronic device. The device includes at least one processing unit; and at least one memory coupled to the at least one processing unit and storing instructions executable by the at least one processing unit, the instructions, when executed by the at least one processing unit, causing the device to perform the steps of the method of the first aspect.

In a fourth aspect of the present disclosure, a non-transitory computer-readable storage medium is provided. The non-transitory computer-readable storage medium has a computer program stored thereon which, when executed by an electronic device, causes the electronic device to perform the steps of the method of the first aspect.

It should be understood that the content described in the Summary section of the present invention is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a schematic diagram of an ETL engine-based architecture;

FIG. 3 illustrates a schematic diagram of a process for data processing using an ETL engine;

FIG. 4 illustrates a schematic diagram of an example engine architecture for data processing in accordance with some embodiments of the present disclosure;

FIG. 5 illustrates a schematic diagram of an example process for data processing in accordance with some embodiments of the present disclosure;

FIG. 6A illustrates a schematic diagram of an example process for data processing based on a class bytecode in accordance with some embodiments of the present disclosure;

FIG. 6B illustrates a schematic diagram of an example process for data processing based on a descriptor in accordance with some embodiments of the present disclosure;

FIG. 7 illustrates a flow chart of a process for data processing in accordance with some embodiments of the present disclosure;

FIG. 8 illustrates a block diagram of an apparatus for data processing in accordance with some embodiments of the present disclosure; and

FIG. 9 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it should be understood that the present disclosure may be implemented in various forms and should not be interpreted as limited to the embodiments described herein. On the contrary, these embodiments are provided for a more thorough and complete understanding of the present disclosure. It should be understood that the drawings and embodiments of the present disclosure are only for the purpose of illustration and are not intended to limit the scope of protection of the present disclosure.

In the description of the embodiments of the present disclosure, the term “including” and similar terms should be understood as open inclusion, that is, “including but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. As used herein, the term “model” can represent the matching degree between various data. For example, the above matching degree can be obtained based on various technical solutions currently available and/or to be developed in the future.

It should be understood that the data involved in this technical proposal (including but not limited to the data itself, data acquisition or use) shall comply with the requirements of corresponding laws, regulations and relevant provisions.

It should be understood that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It should be understood that the above notification and acquisition of user authorization process are only schematic and do not limit the embodiments of the present disclosure. Other methods that meet relevant laws and regulations may also be applied to the implementation of the present disclosure.

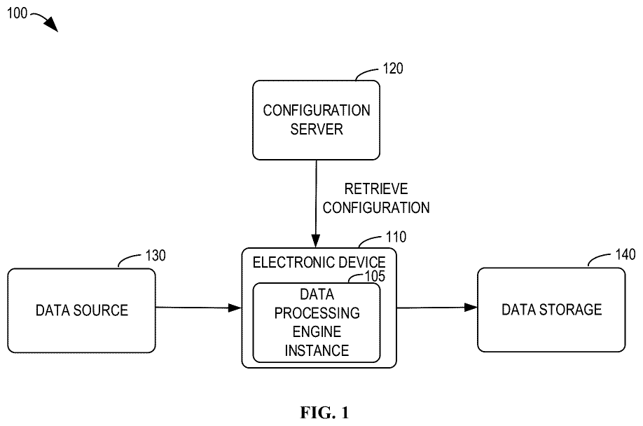

FIG. 1 illustrates a schematic diagram of an example environment 100 in which embodiments of the present disclosure can be implemented. The environment 100 involves one or more data sources 130, one or more data storage 140, an electronic device 110 and a configuration server 120. The electronic device 110 may retrieve a configuration from the configuration server 120. The configuration is used for data processing associated with data from the data source 130. The configuration server 120 may store various rule configurations and metadata and the like.

The data source 130 may be an online or offline data source, and may be or may include relational databases, non-relational databases, file systems (such as CSV, JSON files, etc.), real-time data streams, and various cloud services. The data input from the data source 130 to the electronic device 110 may be represented in a serialized bitstream and referred to as data upstream. The data storage 140 may include data warehouses, data lakes, or other databases, etc., to support various data-driven applications such as data analysis, report generation, data mining, and so on. Data output from the electronic device 110 to the data storage 140 may be represented in a serialized bitstream and referred to as data downstream.

In some examples, if the data from the data source 130 is represented in a serialized bitstream, the electronic device 110 may deserialize the data and then perform data processing on the deserialized data. After the data processing, the electronic device 110 may serialize the processed data and output the serialized data to the data storage 140.

In some examples, the electronic device 110 may retrieve the configuration for generating a data processing engine instance 105. The data processing engine instance 105 may be used to process data from one or multiple data sources and dump them into one or multiple data storages. For example, the electronic device 110 may receive the data upstream from the data source 130 and process data from the data upstream using the data processing engine instance 105.

It should be understood that the structure and function of each element in the environment 100 is described for illustrative purposes only and does not imply any limitations on the scope of the present disclosure.

The shunting task is currently one of the specific manifestations of all event-based streaming tasks. At the same time, it is also the inevitable path for the processing of a large number of core business data. Its main responsibility is to, according to different filtering conditions and rules required by different business parties, deserialize the data at the input end, perform operations such as splitting, deleting, adding, or transforming it into new fields, and then reserialize it and distribute it to different downstream systems for business consumption. In the shunting task, the ETL engine plays a crucial role. The quality of its performance directly affects the performance of the entire link.

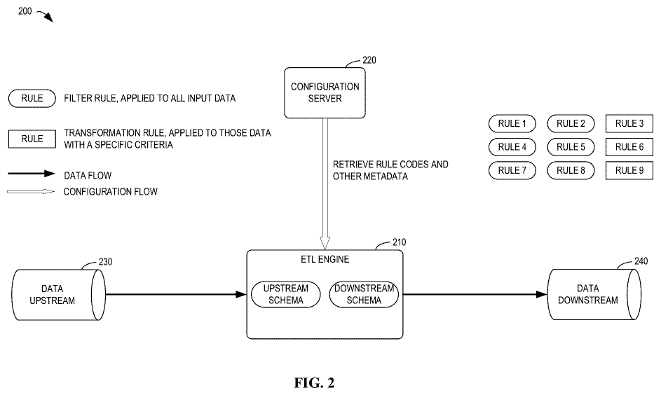

FIG. 2 illustrates a schematic diagram of an ETL engine-based architecture 200. The architecture 200 involves an ELT engine 210 and a configuration server 220. In response to receive data to be processed from the data upstream 230, the ELT engine 210 retrieves the rule code and other metadata from the configuration server 220 to process the data and output the result to the data downstream 240. In actual scenarios, each piece of data is dynamically deserialized, the corresponding rule code is dynamically complied and executed to be applied to the deserialized data, and the final processed data is serialized to generate the corresponding output to be sent to the data downstream 240.

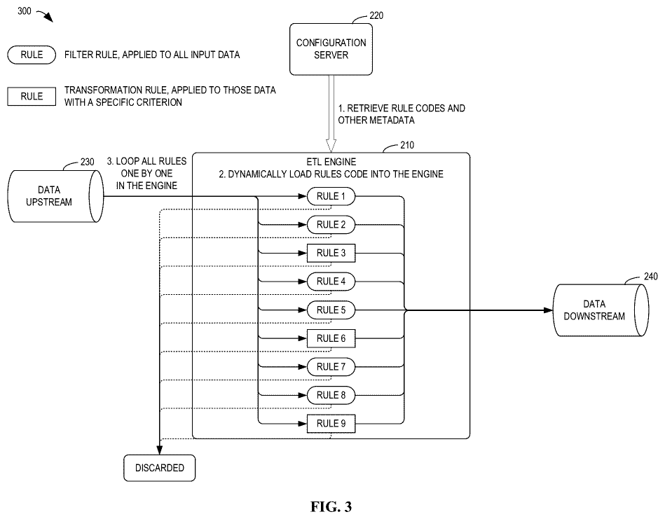

FIG. 3 illustrates a schematic diagram of a process 300 for data processing using the ETL engine. In step 1, the rule code and other metadata from the configuration server 220 are input into the ETL engine 210. In step 2, the rule code is dynamically loaded into the ETL engine 210. The ETL engine 210 may execute the rule code and compile a plurality of rules. In step 3, all the rules are looped. For example, each of the filter rules is applied to all input data, and each of the transformation rules is also applied to the data. Each piece of input data goes through the ETL engine for rule looping, and each rule needs to be dynamically loaded once when it is applied. That is, the corresponding nine rules would be applied one by one to determine whether downstream data needs to be produced for the current data. From this, it can be seen that, at the current runtime of ETL engine, all rules, regardless of their types, would be fully looped. For each of the rules, the data that fails to satisfy the corresponding rule may be discarded, and the data that passes the corresponding rule may be provided to the data downstream 240.

Currently, most implementations of the ETL engine rely on existing big data development frameworks to dynamically load the rule code into the current running environment. The ETL engine can be developed in a targeted manner by combining its own business attributes, enabling rapid input and output, which has obvious advantages in the early stage. However, with the continuous development of the business, the ETL engine also faces many challenges. The most core of these is that the rapidly growing business brings a large number of filtering condition rules and events that need to be processed, imposing huge performance pressure on the ETL engine.

Generally speaking, for the input data, the ETL engine performs a series of parsing and transformations on it according to predefined rules, to ensure that it meets the required format and quality standards before being loaded into a data warehouse or any other analysis platform. The ETL engine would cycle through each rule in turn to parse the input data. However, as the number of rules grows day by day, resource consumption becomes more and more serious. At the same time as the number of rules increases, the cost of processing an event also increases. The amount of data would continue to rise in the short term with the continuous development of the business.

The overall processing cost increases rapidly under the influence of the above factors, resulting in two stages of results without changing the core ETL engine. In the first stage, a huge number of resources is consumed to support the current volume of events, and the input-output ratio decreases day by day. In the second stage, the resource bottleneck would be reached, and it would be unable to support the growth of new events, hindering business growth. In addition, since the serialization and deserialization of the current data schema both adopt dynamic operations, there are further performance losses.

In summary, with the continuous development on data processing, the ETL engine faces the problems of rapidly increasing resource consumption and performance degradation due to its inability to efficiently bear the increasing load. These two problems interact with and reinforce each other, and the speed of resource supply is bound to be difficult to catch up with the load growth brought about by the business growth rate. Therefore, how to effectively improve the performance of the ETL engine and exert the greatest possible performance with as few resources as possible has become the key to solving the problem. Therefore, designing a high-performance ETL engine is of great significance for solving these problems.

According to embodiments of the present disclosure, an improved solution for data processing is proposed. In the solution, an electronic device obtains a data processing engine instance with static code for a set of processing rules compiled therein. The set of processing rules is configured for at least one party. In response to receiving first data to be processed from a first party of the at least one party, the electronic device determines at least one first processing rule from the set of processing rules to be applied to the first data based on a data type of the first data. The electronic device process, using the data processing engine instance, the first data by applying the at least one first processing rule, to obtain the processed first data.

In this way, using the data processing engine instance, all processing rules can be loaded at one time, which improves performance and reduces resource consumption.

In the following, some example embodiments of the present disclosure will be described in detail with reference to the accompanying drawings.

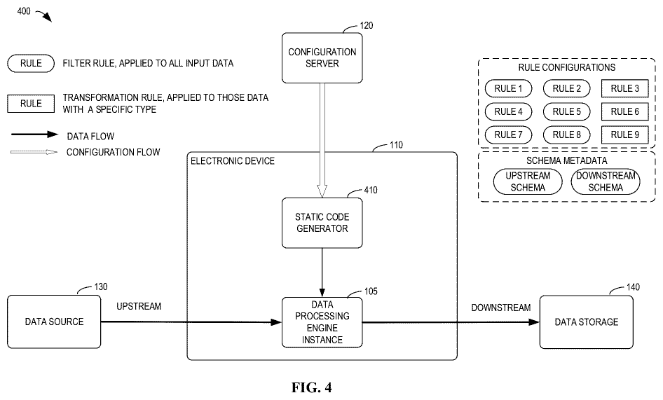

Reference is now made to FIG. 4, which illustrates a schematic diagram of an example engine architecture 400 for data processing in accordance with some embodiments of the present disclosure. The engine architecture 400 involves the electronic device 110 and the configuration server 120. The electronic device 110 includes the data processing engine instance 105 and a static code generator 410. The engine architecture 400 will be described with reference to FIG. 1.

The configuration server 120 may store a rule logic configuration for a set of processing rules (e.g., Rules 1-9 or any other suitable number of rules) and a static definition of data schema. A processing rule may include a predetermined logic for processing data. The rule logic configuration includes code and logic definitions, which are used to configure the initial state or settings of the data processing engine instance 105 and define how input data is extracted, transformed, and loaded. The code is not the one for dynamic execution. In other words, the code would not be just-in-time compiled or interpreted for execution during the process of data processing.

The static definition of the data schema may include defining data formats, data structures, and data types, such as layout, field names, relationships between fields, and data constraints. Once defined, the data schema remains unchanged during the process of data processing and can be reused in different data processing flows. Using a statically defined data schema helps ensure the consistency and accuracy of data during the extraction, transformation, and loading processes.

In some embodiments, the configuration server 120 may further store schema metadata and other metadata. The static definition of the data schema provides the basic framework of the data structure, while the schema metadata provides more details and contextual information about this framework. As shown in FIG. 4, the schema metadata may include upstream schema metadata and downstream schema metadata. The schema metadata may be used to guide the parsing and transformation of data. It ensures that when data is transmitted between different systems or applications, its structure and meaning are correctly understood and processed.

The static code generator 410 may be used to generate the static code for the set of processing rules based on the rule logic configuration and the static definition of data schema. For example, the rule logic configuration, the static definition of data schema, the schema metadata and other metadata are obtained from the configuration server 120. The static code generator 410 may combine the metadata information, structure the logical rules and generate the corresponding Java static code.

In some examples, the static code generator 410 may include an embedded compiler used to compile the static code generated at runtime to generate the data processing engine instance 105. Afterwards, the data processing engine instance 105 may be initialized to perform the process of data processing.

In some examples, the data processing engine instance 105 may be included in an engine for extracting, transforming and loading data which may include more than one data processing engine instance. For example, the data processing engine instance 105 may obtain data from various types of data sources (referred to as party providing data), provide data transformation functions such as data cleaning, data format conversion, and data aggregation or the like, and load the transformed data into the target data storage. The data processing engine instance 105 may further perform execution plans of user-defined ETL tasks, including scheduled execution and periodic execution and the like, and manage the metadata related to the ETL process in a complex manner.

According to the above functions, the working stages of the data processing engine instance 105 may include a configuration stage, an extraction stage, a transformation stage, and a loading stage. In the configuration stage, the data processing engine instance 105 may obtain configuration information (at least including the rule logic configuration, and probably the static definition of the data schema) from the configuration server 120 and then generate an execution plan based on the configuration information. In the extraction stage, the data processing engine instance 105 may establish a connection with the data source 130 according to the configured extraction rules and reads data from the data source. In the transformation stage, the data processing engine instance 105 processes the data according to the predefined processing rules. These processing rules may include simple field mappings and data type conversions, or they may be complex logic processing. In the loading stage, the data processing engine instance 105 may load the transformed data into the data storage 140.

As discussed above, the electronic device 110 may receive data from the data source 130 as input to the data processing engine instance 105. The data source 130 may include data to be processed from at least one party. Herein, a party may be referred to an entity or organization that may provide data to a data source. For example, a party may be an individual, company, or organization that generates or collects data and supplies it to the data source 130, or the party may be a partner that has a cooperative relationship with the owner or operator of the electronic device 110.

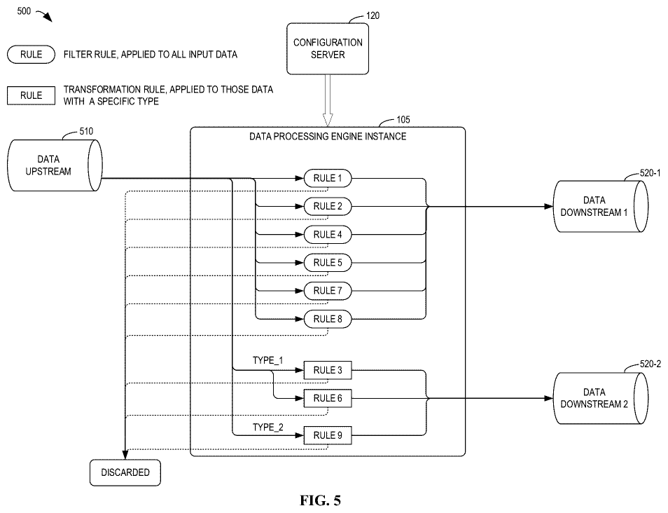

The architecture 400 has been described with reference to FIG. 4, how to obtain the data processing engine instance 105 and perform the data processing for input data will be described with reference to FIG. 5 below.

FIG. 5 illustrates a schematic diagram of an example process 500 for data processing in accordance with some embodiments of the present disclosure. The process 500 may be implemented in the architecture 400 and performed by the electronic device 110. The following will describe the details with reference to FIG. 1.

The electronic device 110 obtains the data processing engine instance 105 with static code for a set of processing rules compiled therein. The set of processing rules is configured for at least one party. The electronic device 110 receives first data to be processed from a first party. The first data has a data type, e.g., event name. The first party is one of the at least one party.

In response to receiving the first data to be processed, the electronic device 110 determines at least one first processing rule from the set of processing rules to be applied to the first data based on the data type of the first data. For example, if the first data has an event type 1, a single or a subset of processing rules from all processing rules would be determined for the first data.

Upon determining the first processing rule(s), the electronic device 110 processes the first data by applying the determined first processing rule(s) using the data processing engine instance 105. Then, the processed first data is obtained.

Before implementing the operations described above, the electronic device 110 needs to obtain the static code for all the processing rules. In some examples, the electronic device 110 may obtain a rule logic configuration for the set of processing rules and a static definition of data schema. Then, the electronic device 110 may generate the static code for the processing rules based on the rule logic configuration and the static definition of data schema, for example, using the static code generator 410. Details with regards to the rule logic configuration and the static definition of data schema may refer to the foregoing description, which will not be repeated here.

After obtaining the static code, the electronic device 110 may compile the static code to generate the data processing engine instance 105. In some examples, the electronic device 110 may generate the data processing engine instance by compiling the static code for the set of processing rules, for example, using the embedded compiler in the static code generator 410. Then, the electronic device 110 may initialize the generated data processing engine instance 105. Such data processing engine instance 105 may be used in the actual scenarios for data processing. In this way, generating static engine code based on rule configurations may improve code execution performance, avoiding dynamically loading the required rules each time processing rules are applied to the data to be processed.

After obtaining the data processing engine instance 105, the electronic device 110 may apply the corresponding processing rules on the data upstream 510 and output the data downstream, e.g., data downstream 510-1, data downstream 510-2. To determine the corresponding processing rules, in some examples, the electronic device 110 may determine rule types (e.g., a filter rule for filtering data or transformation rule for transforming data each associated with a predetermined data type) of all the processing rules. If it is determined that all the processing rules include a subset of filter rules, the electronic device 110 may determine the subset of filter rules to be applied to data (e.g., first data) from the data upstream 510. Such determination may be based on the requirements of the party (e.g., first party). If it is determined that all the processing rules include a subset of transformation rules, the electronic device 110 may determine whether the data type of the first data matches a predetermined data type associated with at least one transformation rule among the subset of transformation rules. If it is determined that the data type of the first data matches the predetermined data type, the electronic device 110 may determine the at least one transformation rule to be applied to the first data. In this way, looping is performed for the filter type, and class dictionary queries are performed for the transformation type, rather than uniform looping.

As shown in FIG. 5, all the processing Rules include rules 1 to 9, where Rules 1, 2, 4, 5, 7 and 8 are filter rules, and Rules 3, 6 and 9 are transformation rules. Upon receiving the first data in the data upstream 510, Rules 1, 2, 4, 5, 7 and 8 are applied to the first data, respectively. The first data processed by applying filter rules would be output as the data downstream 520-1. If the data type of the first data matches Type-1, Rules 3 and 6 are further applied to the first data, respectively. If the data type of the first data matches Type-2, Rule 9 is further applied to the first data. The first data processed by applying transformation rules would be output as the data downstream 520-2. It should be noted that the electronic device 110 may process the first data from the first party based on the processing rules predetermined by the first party and output one or more data downstream based on the requirements of the first party, which is not limited in this regard. During this process, certain data or data segmentation may be discarded.

Regardless of which party configured the filter rules, they may be directly looped, meaning that each piece of data would be processed by applying the filter rules in a one-time pass. If the filter rule is met, the processed first data may be output to the data storage. If the filer rule is not met, the processed first data may be automatically discarded. Meanwhile, if the data type of this piece of data also meets the rule condition corresponding to the transformation rule, such as matching an event name, those relevant transformation rules are applied, rather than running all transformation rules, to the data.

In view of the above, the primary distinction of the data processing engine instance 105 provided by the present disclosure during runtime lies in its ability to differentiate between various processing rule types and employ grouping strategies to enhance runtime efficiency. As depicted in FIG. 5, for all filter-type rules, it would still be executed one by one to determine whether downstream data needs to be produced for the current data. However, for transformation-type rules, a map-like structure is utilized to group and implement only the relevant rules for specific events. For instance, for Type_1, only Rules 3 and 6 are applied among all transformation-type rules, while Rule 9 is bypassed.

In some examples, in response to receiving second data to be processed from a second party, the electronic device 110 may determine at least one second processing rule from all the processing rules to be applied to the second data based on a data type of the second data. After the determination, the electronic device 110 may process, using the data processing engine instance 105, the second data by applying the second processing rule(s), to obtain the processed second data. The way to process the second data is similar to the way to process the first data, for example, by looping all the filter rules and applying the transformation rule(s) matching the data type of the second data. In this way, no matter which party the data comes from, the data processing engine instance 105 can process the data in the same way, avoiding dynamically loading the processing rules multiple times. It would be appreciated that the data processing engine instance 105 may be configured to process data from any number of parities or data sources.

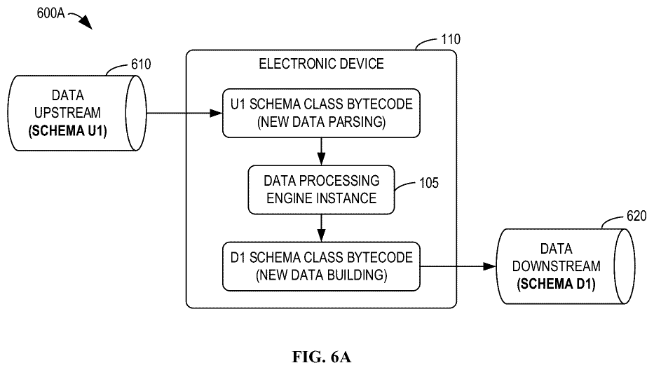

In some embodiments, the present disclosure also provides a solution that can improve the performance of data deserialization and serialization, which will be described below with reference to FIGS. 6A and 6B.

In some examples, if the received first data is represented in a serialized bitstream (e.g., data upstream 610 shown in FIGS. 6A and 6B), the electronic device 110 may first deserialize the first data based on a static definition of data schema to obtain deserialized first data. Then, the electronic device 110 may determine the corresponding processing rules and apply them to the first data deserialized, to obtain the processed first data. The electronic device 110 may serialize the processed first data based on the static definition of data schema, to output the processed first data in a further serialized bitstream (e.g., data downstream 620 shown in FIGS. 6A and 6B).

In some examples, as shown in FIG. 6A, the static definition of data schema may be defined with a class bytecode of at least one data field, and the electronic device 110 may deserialize the received first data using the class bytecode of the at least one data field to obtain the deserialized first data. The deserialized first data is input into the data processing engine instance 105. After data processing, the data processing engine instance 105 may output the processed first data. The electronic device 110 may serialize the processed first data using the class bytecode of the at least one data field, to output the serialized first data in the further serialized bitstream, i.e., the data downstream 620. After compiling the data structure into bytecode, the first data can be directly serialized and deserialized, improving the performance of data serialization and deserialization.

In some examples, as shown in FIG. 6B, the static definition of data schema may be defined with a descriptor of at least one data field, and the electronic device 110 may deserialize a segmentation of the received first data using the descriptor of the at least one data field to obtain a deserialized segmentation of the first data. The deserialized first data is input into the data processing engine instance 105. During the data processing procedure, the determined first processing rule may be applied to the deserialized segmentation of the first data. After the data processing, the data processing engine instance 105 may output the processed first data. The electronic device 110 may serialize the processed segmentation of the first data using the descriptor, to output the processed segmentation of the first data in the further serialized bitstream. Defining data structures using descriptors allows for greater flexibility by parsing only the required data segmentations.

In summary, according to the embodiments of the present disclosure, by generating static code, it brings significant performance optimization benefits on the same resources. For the data schema, static code can be used instead of dynamic loading, which greatly improves performance of data deserialization and serialization.

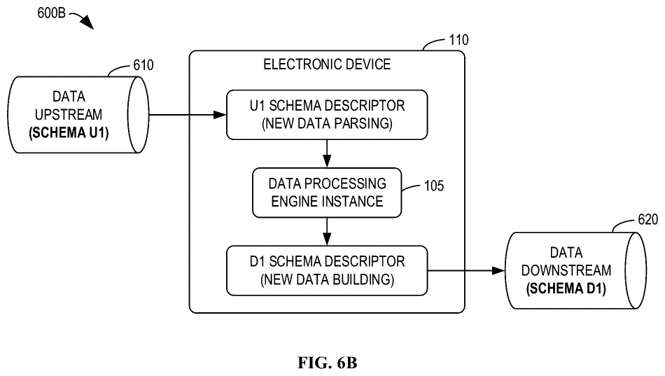

FIG. 7 illustrates a flow chart of a process 700 for data processing in accordance with some embodiments of the present disclosure. The process 700 can be implemented at a terminal device which operates for data processing. For the purpose of discussion, the process 200 will be described with reference to FIG. 1. Thus, the process 700 is implemented at the electronic device 110 of FIG. 1.

At block 710, the electronic device 110 obtains a data processing engine instance with static code for a set of processing rules compiled therein, the set of processing rules being configured for at least one party.

At block 720, the electronic device 110 in response to receiving first data to be processed from a first party of the at least one party, determines at least one first processing rule from the set of processing rules to be applied to the first data based on a data type of the first data.

At block 730, the electronic device 110 processes, using the data processing engine instance, the first data by applying the at least one first processing rule, to obtain the processed first data.

In some embodiments of the present disclosure, the electronic device 110 obtains a rule logic configuration for the set of processing rules and a static definition of data schema; and generates the static code for the set of processing rules based on the rule logic configuration and the static definition of data schema.

In some embodiments of the present disclosure, the electronic device 110 generates the data processing engine instance by compiling the static code for the set of processing rules; and initializes the data processing engine instance generated.

In some embodiments of the present disclosure, the electronic device 110 in accordance with a determination that the set of processing rules comprise a subset of filter rules for filtering data, determines the subset of filter rules to be applied to the first data; in accordance with a determination that the set of processing rules comprise a subset of transformation rules for transforming data each associated with a predetermined data type from the at least one party, determines whether the data type of the first data matches a predetermined data type associated with at least one transformation rule among the subset of transformation rules; and in accordance with a determination that the data type of the first data matches the predetermined data type, determines the at least one transformation rule to be applied to the first data.

In some embodiments of the present disclosure, the received first data is represented in a serialized bitstream, and the electronic device 110 deserializes the received first data based on a static definition of data schema to obtain deserialized first data, wherein the at least one first processing rule is applied to the deserialized first data; and serializes the processed first data based on the static definition of data schema, to output the processed first data in a further serialized bitstream.

In some embodiments of the present disclosure, the static definition of data schema is defined with a class bytecode of at least one data field, the electronic device 110 deserializes the received first data using the class bytecode of the at least one data field to obtain the deserialized first data, and wherein the least one first processing rule is applied to the deserialized first data; and the electronic device 110 serializes the processed first data using the class bytecode of the at least one data field, to output the serialized first data in the further serialized bitstream.

In some embodiments of the present disclosure, the static definition of data schema is defined with a descriptor of at least one data field, the electronic device 110 descrializes a segmentation of the received first data using the descriptor of the at least one data field to obtain a deserialized segmentation of the first data, and wherein the at least one first processing rule is applied to the deserialized segmentation of the first data; and the electronic device 110 serializes the processed segmentation of the first data using the descriptor, to output the processed segmentation of the first data in the further serialized bitstream.

In some embodiments of the present disclosure, the electronic device 110 in response to receiving second data to be processed from a second party of the at least one party, determines at least one second processing rule from the set of processing rules to be applied to the second data based on a data type of the second data; and processes, using the data processing engine instance, the second data by applying the at least one second processing rule, to obtain the processed second data.

In some embodiments of the present disclosure, the data processing engine instance is comprised in an engine for extracting, transforming and loading data.

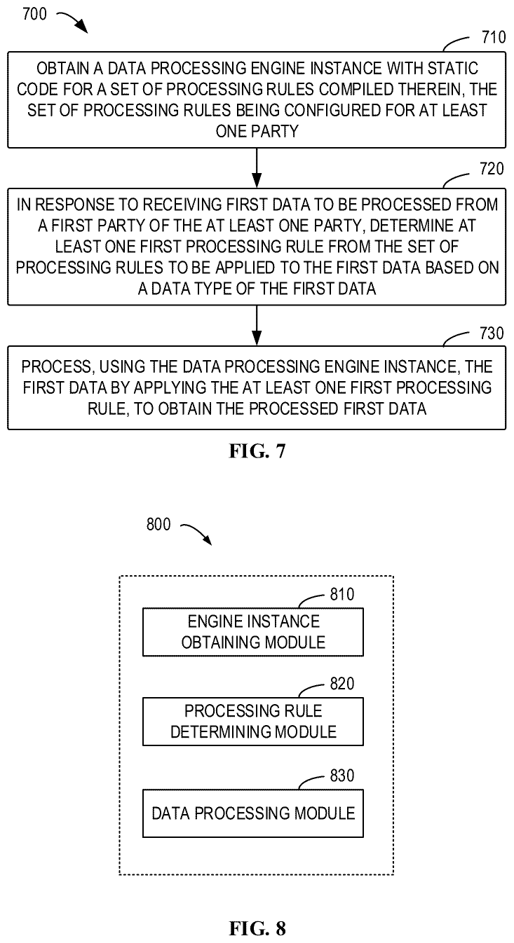

FIG. 8 illustrates a block diagram of an apparatus 800 for data processing in accordance with some embodiments of the present disclosure. The apparatus 800 may be implemented, for example, or included at the electronic device 110 of FIG. 1. Various modules/components in the apparatus 800 may be implemented by hardware, software, firmware, or any combination thereof.

As shown, the apparatus 800 includes an engine instance obtaining module 810, configured to obtain a data processing engine instance with static code for a set of processing rules compiled therein, the set of processing rules being configured for at least one party. The apparatus 800 further includes a processing rule determining module 820, configured to in response to receiving first data to be processed from a first party of the at least one party, determine at least one first processing rule from the set of processing rules to be applied to the first data based on a data type of the first data. The apparatus 800 further includes a data processing module 830, configured to process, using the data processing engine instance, the first data by applying the at least one first processing rule, to obtain the processed first data.

In some embodiments, the apparatus 800 further includes a rule logic configuration and static definition obtaining module, configured to obtain a rule logic configuration for the set of processing rules and a static definition of data schema; and a static code generating module, configured to generate the static code for the set of processing rules based on the rule logic configuration and the static definition of data schema.

In some embodiments, the apparatus 800 further includes a data processing engine instance generating module, configured to generate the data processing engine instance by compiling the static code for the set of processing rules; and an initialization module, configured to initialize the data processing engine instance generated.

In some embodiments, the processing rule determining module 820 is further configured to in accordance with a determination that the set of processing rules comprise a subset of filter rules for filtering data, determine the subset of filter rules to be applied to the first data; in accordance with a determination that the set of processing rules comprise a subset of transformation rules for transforming data each associated with a predetermined data type from the at least one party, determine whether the data type of the first data matches a predetermined data type associated with at least one transformation rule among the subset of transformation rules; and in accordance with a determination that the data type of the first data matches the predetermined data type, determine the at least one transformation rule to be applied to the first data.

In some embodiments, the apparatus 800 further includes a data deserializing module, configured to deserialize the received first data based on a static definition of data schema to obtain deserialized first data, wherein the at least one first processing rule is applied to the deserialized first data; and a data serializing module, configured to serialize the processed first data based on the static definition of data schema, to output the processed first data in a further serialized bitstream.

In some embodiments, the static definition of data schema is defined with a class bytecode of at least one data field, the data deserializing module is configured to deserialize the received first data using the class bytecode of the at least one data field to obtain the deserialized first data, and wherein the least one first processing rule is applied to the deserialized first data; and the data serializing module is configured to serialize the processed first data using the class bytecode of the at least one data field, to output the serialized first data in the further serialized bitstream.

In some embodiments, the static definition of data schema is defined with a descriptor of at least one data field, the data deserializing module is configured to deserialize a segmentation of the received first data using the descriptor of the at least one data field to obtain a deserialized segmentation of the first data, and wherein the at least one first processing rule is applied to the deserialized segmentation of the first data; and the data serializing module is configured to serialize the processed segmentation of the first data using the descriptor, to output the processed segmentation of the first data in the further serialized bitstream.

In some embodiments, the apparatus 800 further includes a second processing rule determining module, configured to in response to receiving second data to be processed from a second party of the at least one party, determine at least one second processing rule from the set of processing rules to be applied to the second data based on a data type of the second data; and a second data processing module, configured to process, using the data processing engine instance, the second data by applying the at least one second processing rule, to obtain the processed second data.

In some embodiments, the data processing engine instance is comprised in an engine for extracting, transforming and loading data.

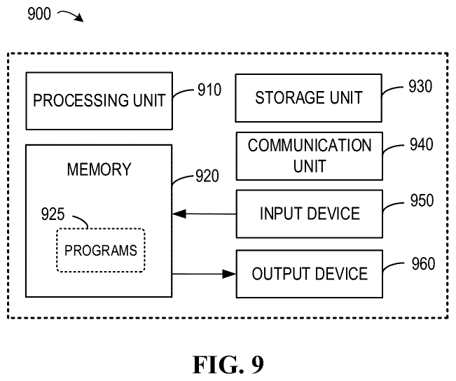

FIG. 9 illustrates a block diagram of an electronic device 900 in which one or more embodiments of the present disclosure can be implemented. It should be understood that the electronic device 900 shown in FIG. 9 is only an example and should not constitute any restriction on the function and scope of the embodiments described herein. The electronic device 900 may be used, for example, to implement the electronic device 110 of FIG. 1. The electronic device 900 may also be configured to implement the apparatus 800 of FIG. 8.

As shown in FIG. 9, the electronic device 900 is in the form of a general computing device. The components of the electronic device 900 may include, but are not limited to, one or more processors or processing units 910, a memory 920, a storage device 930, one or more communication units 940, one or more input devices 950, and one or more output devices 960. The processing unit 910 may be an actual or virtual processor and can execute various processes according to the programs stored in the memory 920. In a multiprocessor system, multiple processing units execute computer executable instructions in parallel to improve the parallel processing capability of the electronic device 900.

The electronic device 900 typically includes a variety of computer storage medium. Such medium may be any available medium that is accessible to the electronic device 900, including but not limited to volatile and non-volatile medium, removable and non-removable medium. The memory 920 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 930 may be any removable or non-removable medium, and may include a machine-readable medium, such as a flash drive, a disk, or any other medium, which can be used to store information and/or data (such as training data for training) and can be accessed within the electronic device 900.

The electronic device 900 may further include additional removable/non-removable, volatile/non-volatile storage medium. Although not shown in FIG. 9, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 920 may include a computer program product 925, which has one or more program modules configured to perform various methods or acts of various embodiments of the present disclosure.

The communication unit 940 communicates with a further computing device through the communication medium. In addition, the functions of components in the electronic device 900 may be implemented by a single computing cluster or multiple computing machines, which can communicate through a communication connection. Therefore, the electronic device 900 may be operated in a networking environment using a logical connection with one or more other servers, a network personal computer (PC), or another network node.

The input device 950 may be one or more input devices, such as a mouse, a keyboard, a trackball, etc. The output device 960 may be one or more output devices, such as a display, a speaker, a printer, etc. The electronic device 900 may also communicate with one or more external devices (not shown) through the communication unit 940 as required. The external device, such as a storage device, a display device, etc., communicate with one or more devices that enable users to interact with the electronic device 900, or communicate with any device (for example, a network card, a modem, etc.) that makes the electronic device 900 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It should be understood that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method of data processing, comprising:
obtaining a data processing engine instance with static code for a set of processing rules compiled therein, the set of processing rules being configured for at least one party;
in response to receiving first data to be processed from a first party of the at least one party, determining at least one first processing rule from the set of processing rules to be applied to the first data based on a data type of the first data; and
processing, using the data processing engine instance, the first data by applying the at least one first processing rule, to obtain the processed first data.

2. The method of claim 1, further comprising:
obtaining a rule logic configuration for the set of processing rules and a static definition of data schema; and
generating the static code for the set of processing rules based on the rule logic configuration and the static definition of data schema.

3. The method of claim 2, wherein obtaining the data processing engine instance comprises:
generating the data processing engine instance by compiling the static code for the set of processing rules; and
initializing the data processing engine instance generated.

4. The method of claim 1, wherein determining the at least one first processing rule from the set of processing rules to be applied to the first data based on the data type of the first data comprises:
in accordance with a determination that the set of processing rules comprise a subset of filter rules for filtering data, determining the subset of filter rules to be applied to the first data;
in accordance with a determination that the set of processing rules comprise a subset of transformation rules for transforming data each associated with a predetermined data type from the at least one party,
determining whether the data type of the first data matches a predetermined data type associated with at least one transformation rule among the subset of transformation rules; and
in accordance with a determination that the data type of the first data matches the predetermined data type, determining the at least one transformation rule to be applied to the first data.

5. The method of claim 1, wherein the received first data is represented in a serialized bitstream, and the method further comprises:
deserializing the received first data based on a static definition of data schema to obtain deserialized first data, wherein the at least one first processing rule is applied to the deserialized first data; and
serializing the processed first data based on the static definition of data schema, to output the processed first data in a further serialized bitstream.

6. The method of claim 5, wherein the static definition of data schema is defined with a class bytecode of at least one data field, and
wherein deserializing the received first data comprises: deserializing the received first data using the class bytecode of the at least one data field to obtain the deserialized first data, and wherein the least one first processing rule is applied to the deserialized first data; and
wherein serializing the processed first data comprises: serializing the processed first data using the class bytecode of the at least one data field, to output the serialized first data in the further serialized bitstream.

7. The method of claim 5, wherein the static definition of data schema is defined with a descriptor of at least one data field, and
wherein deserializing the received first data comprises: deserializing a segmentation of the received first data using the descriptor of the at least one data field to obtain a deserialized segmentation of the first data, and wherein the at least one first processing rule is applied to the deserialized segmentation of the first data; and
wherein serializing the processed first data comprises: serializing the processed segmentation of the first data using the descriptor, to output the processed segmentation of the first data in the further serialized bitstream.

8. The method of claim 1, further comprising:
in response to receiving second data to be processed from a second party of the at least one party, determining at least one second processing rule from the set of processing rules to be applied to the second data based on a data type of the second data; and
processing, using the data processing engine instance, the second data by applying the at least one second processing rule, to obtain the processed second data.

9. The method of claim 1, wherein the data processing engine instance is comprised in an engine for extracting, transforming and loading data.

10. An electronic device, comprising a computer processor coupled to a computer-readable memory unit, the memory unit comprising instructions that when executed by the computer processor implements the method of data processing, the method comprising:
obtaining a data processing engine instance with static code for a set of processing rules compiled therein, the set of processing rules being configured for at least one party;
in response to receiving first data to be processed from a first party of the at least one party, determining at least one first processing rule from the set of processing rules to be applied to the first data based on a data type of the first data; and
processing, using the data processing engine instance, the first data by applying the at least one first processing rule, to obtain the processed first data.

11. The device of claim 10, wherein the method further comprises:
obtaining a rule logic configuration for the set of processing rules and a static definition of data schema; and
generating the static code for the set of processing rules based on the rule logic configuration and the static definition of data schema.

12. The device of claim 11, wherein obtaining the data processing engine instance comprises:
generating the data processing engine instance by compiling the static code for the set of processing rules; and
initializing the data processing engine instance generated.

13. The device of claim 10, wherein determining the at least one first processing rule from the set of processing rules to be applied to the first data based on the data type of the first data comprises:
in accordance with a determination that the set of processing rules comprise a subset of filter rules for filtering data, determining the subset of filter rules to be applied to the first data;
in accordance with a determination that the set of processing rules comprise a subset of transformation rules for transforming data each associated with a predetermined data type from the at least one party,
determining whether the data type of the first data matches a predetermined data type associated with at least one transformation rule among the subset of transformation rules; and
in accordance with a determination that the data type of the first data matches the predetermined data type, determining the at least one transformation rule to be applied to the first data.

14. The device of claim 10, wherein the received first data is represented in a serialized bitstream, and the method further comprises:
deserializing the received first data based on a static definition of data schema to obtain deserialized first data, wherein the at least one first processing rule is applied to the deserialized first data; and
serializing the processed first data based on the static definition of data schema, to output the processed first data in a further serialized bitstream.

15. The device of claim 14, wherein the static definition of data schema is defined with a class bytecode of at least one data field, and
wherein deserializing the received first data comprises: deserializing the received first data using the class bytecode of the at least one data field to obtain the deserialized first data, and wherein the least one first processing rule is applied to the deserialized first data; and
wherein serializing the processed first data comprises: serializing the processed first data using the class bytecode of the at least one data field, to output the serialized first data in the further serialized bitstream.

16. The device of claim 14, wherein the static definition of data schema is defined with a descriptor of at least one data field, and
wherein deserializing the received first data comprises: deserializing a segmentation of the received first data using the descriptor of the at least one data field to obtain a deserialized segmentation of the first data, and wherein the at least one first processing rule is applied to the deserialized segmentation of the first data; and
wherein serializing the processed first data comprises: serializing the processed segmentation of the first data using the descriptor, to output the processed segmentation of the first data in the further serialized bitstream.

17. The method of claim 10, wherein the method further comprises:
in response to receiving second data to be processed from a second party of the at least one party, determining at least one second processing rule from the set of processing rules to be applied to the second data based on a data type of the second data; and
processing, using the data processing engine instance, the second data by applying the at least one second processing rule, to obtain the processed second data.

18. The device of claim 10, wherein the data processing engine instance is comprised in an engine for extracting, transforming and loading data.

19. A non-transitory computer readable storage medium, having a computer program stored thereon which, upon execution by an electronic device, causes the device to perform the method of data processing, the method comprising:
obtaining a data processing engine instance with static code for a set of processing rules compiled therein, the set of processing rules being configured for at least one party;
in response to receiving first data to be processed from a first party of the at least one party, determining at least one first processing rule from the set of processing rules to be applied to the first data based on a data type of the first data; and
processing, using the data processing engine instance, the first data by applying the at least one first processing rule, to obtain the processed first data.

20. The non-transitory computer readable storage medium of claim 19, wherein the method further comprises:
obtaining a rule logic configuration for the set of processing rules and a static definition of data schema; and
generating the static code for the set of processing rules based on the rule logic configuration and the static definition of data schema.
